(19) United States
(12) Patent Application Publication
(10) Pub. No.: US 2013/0062088 A1
(43) Pub. Date: Mar. 14, 2013

(54) IMPACT TOOL

(71) Applicants: Hironori Mashiko, Ibaraki (JP); Tomomasa Nishikawa, Ibaraki (JP); Hayato Yamaguchi, Ibaraki (JP)

(72) Inventors: Hironori Mashiko, Ibaraki (JP); Tomomasa Nishikawa, Ibaraki (JP); Hayato Yamaguchi, Ibaraki (JP)

(73) Assignee: HITACHI KOKI CO., LTD., Tokyo (JP)

(21) Appl. No.: 13/579,812

(22) PCT Filed: Feb. 21, 2011
(86) PCT No.: PCT/JP2011/054416

§ 371 Date: Aug. 17, 2012

(30) Foreign Application Priority Data
Feb. 22, 2010 (JP) 2010-036730

(51) Int. Cl. B25B 21/02; B25B 23/147

(52) U.S. Cl. 173/2; 173/48

(57) ABSTRACT

An impact tool including: a motor; a speed-reduction mechanism that reduces a torque of the motor; a hammer connected to an output portion of the speed-reduction mechanism; and an anvil that can be swung relatively to the hammer, wherein the hammer is directly driven by the motor, and wherein the impact tool can operate in: a drill mode in which an end tool attached to the anvil is rotated by rotating the hammer in one direction so as to rotate the anvil; and an impact mode in which the end tool attached to the anvil is rotated while the hammer intermittently strikes the anvil.

### TECHNICAL FIELD

Aspects of the present invention relate to an impact tool that is driven by a motor and realizes a new striking mechanism portion, and specifically to an impact tool that can prevent a coming-out operation in a fastening mode where an impact operation is not performed.

### BACKGROUND ART

An impact tool drives a rotating striking mechanism portion by using a motor as a driving source to apply torque and a striking force to an anvil, so as to intermittently transmit a rotating impact force to an end tool perform an operation such as screwing. In recent years, a brushless DC motor is widely used as the driving source. The brushless DC motor is, for instance, a DC (direct current) motor that does not include a brush (a rectifying brush), and uses a coil (winding wire) in a stator side and a magnet (a permanent magnet) in a rotor side and sequentially supplies an electric power driven in an inverter circuit to a predetermined coil to rotate the rotor. The inverter circuit is formed by using an output transistor of a large capacity such as an FET (Field Effect Transistor) or an IGBT (Insulating Gate Bipolar Transistor) and is driven by a large current. The brushless DC motor has better torque characteristics than that of a DC motor with a brush, and can fasten a screw, a bolt, etc. to a processed member by a stronger force.

JP-A-2009-728888 discloses an example of the impact tool using the brushless DC motor. In JP-A-2009-728888, the impact tool has a continuously rotating type impact mechanism portion. When a torque is applied to a spindle through a power transmitting mechanism portion (a speed-reduction mechanism portion), a hammer, which is engaged with the spindle so as to be movable in a direction of a rotary shaft of the spindle, is rotated, so as to rotate an anvil abutting to the hammer. The hammer and the anvil respectively have two hammer protruding portions (striking portions) which are respectively arranged symmetrically with each other at two positions on a rotation plane. These protruding portions are located at positions where the protruding portions are engaged with each other in a rotating direction. A rotating striking force is transmitted in accordance with the engagement of the protruding portions. The hammer is provided so as to freely slide in the axial direction relative to the spindle within a ring area that surrounds the spindle. An inverted V-shaped (substantially triangular shape) cam groove is provided to an inner peripheral surface of the hammer. A V-shaped cam groove is provided in the axial direction to an outer peripheral surface of the spindle. The hammer is rotated via balls (steel balls) inserted between the cam groove provided to the spindle and the cam groove provided to the hammer.

### SUMMARY OF INVENTION

### Technical Problem

In the related-art power transmitting mechanism portion, the spindle and the hammer are supported via the balls arranged in the cam grooves. The hammer can be retreated rearward in the axial direction relative to the spindle by a spring arranged at a rear end thereof. Accordingly, the hammer is indirectly driven by the motor through a cam mechanism. Thus, the number of components of a power transmitting portion for transmitting power from the spindle to the hammer becomes large. Accordingly, high attaching accuracy between the spindle and the hammer is required, thereby increasing the manufacturing cost.

Meanwhile, in the related-art impact tool, in order to control the impact mechanism not to operate (that is, in order not to perform striking), for example, a mechanism for limiting a retreating operation of the hammer is required. That is, the impact tool of JP-A-2009-728888 cannot be used in a so-called drill mode. Further, even when the drill mode for controlling the retreating operation of the hammer is realized, a clutch mechanism needs to be separately provided to realize a clutch operation for interrupting a transmission of a power when the torque reaches a predetermined fastening torque. Thus, realizing the drill mode or the drill mode with a clutch in an impact tool leads to cost increase.

Accordingly, it is an object of the present invention to provide an impact tool that can realize an impact mechanism by a hammer and an anvil having a simple mechanism and can also be used in a so-called drill mode without operating the impact mechanism.

Another object of the present invention is to provide an impact tool that realizes a drill mode which can greatly restrain a screw and the like from coming-out by designing a driving method of a motor so as to drive a hammer and an anvil in a relative rotation angle smaller than 360 degrees.

Another object of the present invention is to provide an impact tool that controls a rotation of a motor so as to be capable of accurately responding to increase of a fastening load from a fastening object.

### Solution to Problem

Representative features of the present invention are hereinafter described.

According to a first aspect of the present invention, there is provided an impact tool including: a motor; a speed-reduction mechanism that reduces a torque of the motor; a hammer connected to an output portion of the speed-reduction mechanism; and an anvil that can be swung relatively to the hammer, wherein the hammer is directly driven by the motor, and wherein the impact tool can operate in: a drill mode in which an end tool attached to the anvil is rotated by rotating the hammer in one direction so as to rotate the anvil; and an impact mode in which the end tool attached to the anvil is rotated while the hammer intermittently strikes the anvil.

Further, according to a second aspect of the present invention, in the impact tool, the hammer may be capable of being swung at a rotation angle smaller than 360 degrees relative to the anvil.

Further, according to a third aspect of the present invention, in the impact tool, the motor may be intermittently driven in the drill mode.

Further, according to a fourth aspect of the present invention, in the impact tool, the motor may be intermittently driven by alternately supplying to the motor, a first current for rotating the motor in a normal direction, and a second current for rotating the motor in a reverse direction for a short period of time.

Further, according to a fifth aspect of the present invention, in the impact tool, the motor may be intermittently driven by alternately repeating, supplying the first current to the motor, and stopping the supply of the current to the motor for a short period of time.

Further, according to a sixth aspect of the present invention, in the impact tool, an integrated value of the first current may be calculated, and it may be switched from supplying the first current to supplying the second current or stopping the supply of the current when the integrated value reaches a predetermined value.

Further, according to a seventh aspect of the present invention, in the impact tool, the short period of time, during which the second current is supplied or the supply of the current is stopped, may be a predetermined time which is previously set.

Further, according to an eighth aspect of the present invention, in the impact tool, the magnitude of the first current may be monitored, and the rotation of the motor may be stopped when the magnitude of the first current reaches a predetermined value.

Further, according to an ninth aspect of the present invention, in the impact tool, a time required until the integrated value of the first current reaches a predetermined value may be monitored, and when the time is equal to a predetermined value or smaller, the rotation of the motor may be stopped or the mode may be shifted to the impact mode.

### Advantageous Effects of Invention

According to the first aspect of the present invention, since the impact tool in which the hammer is directly driven by the motor includes the drill mode in which the end tool attached to the anvil is rotated by rotating the hammer in one direction so as to rotate the anvil and the impact mode in which the end tool attached to the anvil is rotated while the hammer intermittently strikes the anvil, the drill mode can be realized in the impact tool. Although a speed of the hammer is reduced through a planetary gear speed-reduction mechanism, since the hammer does not have an intentional allowance portion such as a cam mechanism, a driving force of the motor can be transmitted to the hammer without a loss.

According to the second aspect of the present invention, since the hammer can be swung at the rotation angle smaller than 360 degrees relative to the anvil, that is, the hammer cannot be continuously rotated relatively to the anvil, the hammer does not need to be moved in an axial direction and an impact mechanism having a simple structure can be realized.

According to the third aspect of the present invention, since the motor is intermittently driven to rotate the hammer in one direction, the occurrence of a so-called coming-out, for instance, a screw head is surmounted by a bit of the end tool, can be greatly reduced.

According to the fourth aspect of the present invention, since the motor is intermittently driven by alternately supplying to the motor, the first current for rotating the motor in the normal direction, and the second current for rotating the motor in the reverse direction for the short period of time, when the supply of the first current is stopped, a fastening torque by the end tool greatly falls temporarily. Thus, even when a bit of the end tool tries to surmount the screw head, the bit of the end tool is effectively engaged again with the screw head during the fall of the torque, so that the occurrence of the coming-out can be greatly reduced.

According to the fifth aspect of the present invention, since the motor is intermittently driven by alternately repeating, supplying the first current to the motor, and stopping the supply of the current to the motor for the short period of time, when the supply of the first current is stopped, the fastening torque by the end tool slightly falls temporarily. Thus, even when the bit of the end tool tries to surmount the screw head, the bit of the end tool is effectively engaged again with the screw head during the fall of the torque, so that the occurrence of the coming-out can be greatly reduced.

According to the sixth aspect of the present invention, the integrated value of the first current is calculated, and it is switched from supplying the first current to supplying the second current or stopping the supply of the current when the integrated value reaches a predetermined value. Thus, an amount of the fastening torque causing the coming-out can be measured while effectively causing the fastening torque by the bit of the end tool to fall.

According to the seventh aspect of the present invention, since the short period of time, during which the second current is supplied or the supply of the current is stopped, is a predetermined time which is previously set, the supply of the first current can be restarted before the fall of the fastening torque influences a fall of the rotation of the end tool. Accordingly, a fastening operation by the drill mode can be performed under a state that a variation of the fastening torque can be substantially ignored.

According to the eighth aspect of the present invention, the magnitude of the first current is monitored, and the rotation of the motor is stopped when the magnitude of the first current reaches a predetermined value. Thus, the motor can be automatically stopped when the fastening torque reaches a predetermined value. In such a way, since a clutch unit can be electronically realized without using a mechanical clutch mechanism, the increase in a manufacturing cost of an electric tool can be suppressed.

According to the ninth aspect of the present invention, the time required until the integrated value of the first current reaches a predetermined value is monitored, and, when the time is equal to a predetermined value or smaller, the rotation of the motor is stopped or the mode is shifted to the impact mode. Thus, the motor can be automatically stopped when the fastening torque reaches a predetermined value. In such a way, since a clutch unit can be electronically realized without using a mechanical clutch mechanism, the increase in a manufacturing cost of an electric tool can be suppressed. Further, the drill mode can be shifted to the impact mode when more fastening torque is required. Thus, a time required for the entire fastening operation using the impact operation can be shortened.

The above-described objects and other objects and novel features will become apparent from the description of the specification and drawings hereinafter.

### BRIEF DESCRIPTION OF DRAWINGS

FIG. 1 is a longitudinal sectional view showing an entire structure of an impact tool according to an exemplary embodiment of the present invention;

FIG. 2 is a perspective view showing an external appearance of the impact tool according to the exemplary embodiment of the present invention;

FIG. 3 is an enlarged sectional view of a portion in a vicinity of a striking mechanism shown in FIG. 1;

FIG. 4 is a perspective view showing the configuration of a hammer and an anvil shown in FIG. 1;

FIG. 5 is a perspective view showing the configuration of the hammer and the anvil illustrated in FIG. 1 from a different angle;

FIG. 6 is a functional block diagram showing a driving control system of a motor of the impact tool according to the exemplary embodiment of the present invention;

FIG. 7 (7A, 7B, 7C, 7D) is a sectional view taken along a line A-A in FIG. 3 to explain a driving control of the hammer in a “continuous driving mode”;

FIG. 8 (8A, 8B, 8C, 8D, 8E, 8F) is a sectional view taken along a line A-A in FIG. 3 to explain the driving control of the hammer in an “intermittent driving mode”;

FIG. 9 is a current wave form diagram showing a basic driving current control of the motor in the “continuous driving mode” of the impact tool according to the exemplary embodiment of the present invention; and

FIG. 10 is a current wave form diagram showing a current control of an intermittent driving of the motor in a “coming-out preventing mode” of the impact tool according to the exemplary embodiment of the present invention.

### DESCRIPTION OF EMBODIMENTS

### First Exemplary Embodiment

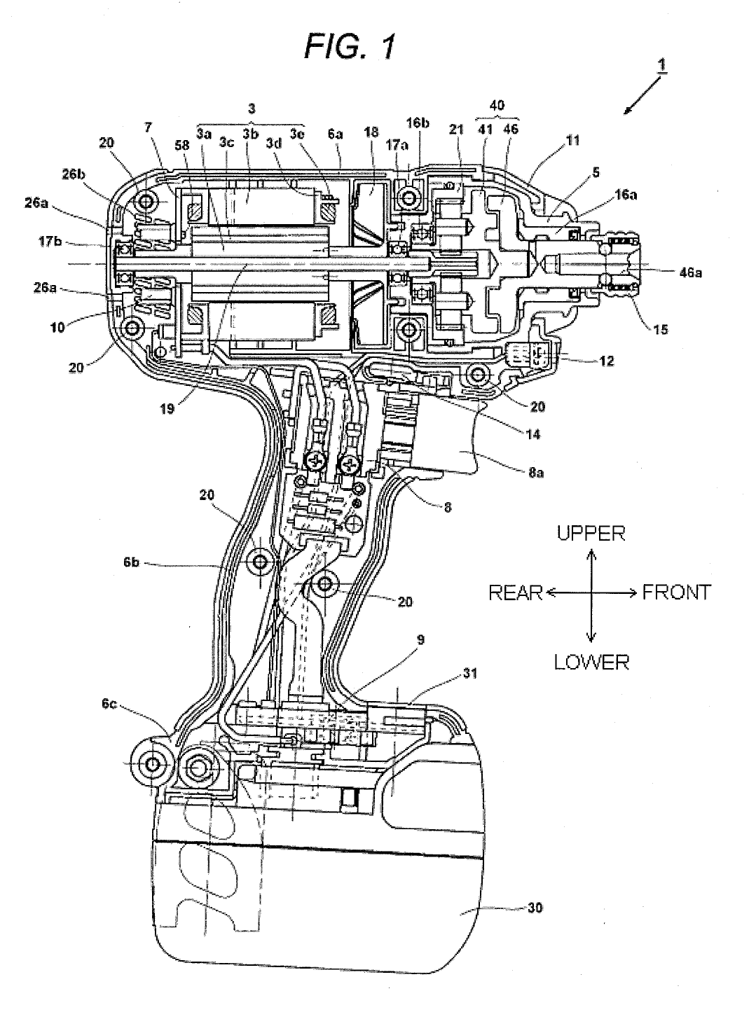

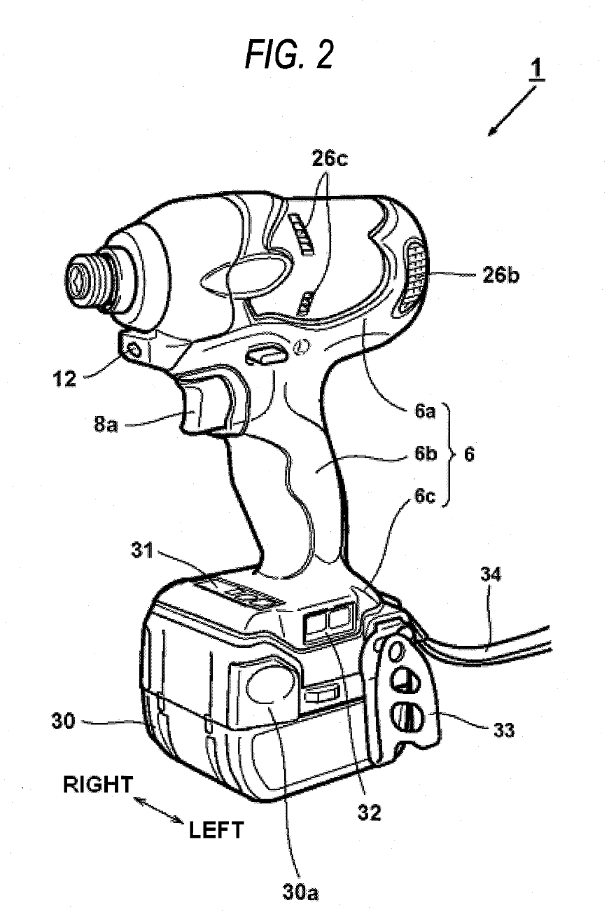

Hereinafter, an exemplary embodiment of the present invention will be described by referring to the drawings. In the following description, upper and lower directions, front and rear directions and right and left directions correspond to directions shown in FIG. 1 and FIG. 2.

FIG. 1 is a longitudinal sectional view showing an entire structure of an impact tool 1 according to the exemplary embodiment of the present invention. The impact tool 1 uses a battery pack 30 that can be charged as a power source and a motor 3 as a driving source to drive an striking mechanism 40 and rotates and an strikes an anvil 46 as an output shaft to transmit a continuous torque or an intermittent striking force to an end tool such as a driver bit not shown in the drawing so as to fasten a screw or a bolt.

The motor 3 is a brushless DC motor and accommodated in a tubular trunk portion 6a of a housing 6 (see FIG. 2) substantially formed in a T shape when seen from a side surface. The housing 6 is formed so as to be divided to two right and left members substantially symmetrical with each other and these members are fixed together by a plurality of screws. Therefore, in one of the divided housing 6 (in the exemplary embodiment, a left side housing), a plurality of screw bosses 20 are formed. In the other (a right side housing), a plurality of tapped holes (not shown in the drawing) are formed. A rotary shaft 19 of the motor 3 is supported so as to freely rotate by a bearing 17b in a rear end side of the trunk portion 6a and a bearing 17a provided in a portion in the vicinity of a central portion. In a rear portion of the motor 3, a board 7 is provided on which six switching elements 10 are mounted. An inverter is controlled by the switching elements 10 to rotate the motor 3. On a front part side of the board 7, a rotating position detecting element 58 such as a Hall element or a Hall IC is mounted to detect a position of a rotor 3a.

In an upper portion in a grip portion 6b integrally extending substantially at right angles to the trunk portion 6a of the housing 6, a trigger switch 8 and a normal/reverse switching lever 14 are provided. In the trigger switch 8, a trigger operating portion 8a is provided that is urged by a spring not shown in the drawing to protrude from the grip portion 6b. In a lower part in the grip portion 6b, a control circuit board 9 is accommodated that has a function for controlling a speed of the motor 3 by the trigger operating portion 8a. In a battery holding portion 6c formed in a lower part of the grip portion 6b of the housing 6, the battery pack 30 in which a plurality of battery cells such as nickel hydrogen or lithium ion are accommodated is detachably attached.

In a front part of the motor 3, a cooling fan 18 that is attached to the rotary shaft 19 and rotates synchronously with the motor 3 is provided. By the cooling fan 18, air is sucked from air intake ports 26a and 26b provided in a rear part of the trunk portion 6a. The sucked air is exhausted outside the housing 6 from a plurality of slits 26c (see FIG. 2) formed in the trunk portion 6a of the housing 6 and in the vicinity of an outer peripheral side in the radial direction of the cooling fan 18.

The striking mechanism 40 is formed of two portions, that is, the anvil 46 and a hammer 41. The hammer 41 is fixed so as to connect together rotary shafts of a plurality of planetary gears of a planetary gear speed-reduction mechanism 21. The hammer 41 does not include a cam mechanism having a spindle, a spring, a cam groove, a ball, etc., differently from a well-known impact mechanism which is presently widely used. The anvil 46 and the hammer 41 are connected to each other by a fitting shaft and a fitting hole formed in a vicinity of a center of rotation, so that only less than one relative rotation can be performed therebetween. The anvil 46 is formed integrally with an output shaft portion to which the end tool not shown in the drawing is attached. In a front end of the anvil, an attaching hole 46a that has a hexagonal cross-sectional shape in an axial direction is formed. A rear side of the anvil 46 is connected to a fitting shaft of the hammer 41 and supported so as to freely rotate relative to a case 5 by a metal bearing 16a in a part near a central portion in the axial direction.

The case 5 is integrally formed from metal to accommodate the striking mechanism 40 and the planetary gear speed-reduction mechanism 21, and attached to the front side of the housing 6. Further, an outer peripheral side of the case 5 is covered with a cover 11 made of a resin to prevent the transmission of heat and achieve an impact absorbing effect. In an end of the anvil 46, an end tool holding unit is formed for holding the end tool. The end tool is detached and attached by moving a sleeve 15 forward and backward.

In the impact tool 1, when the trigger operating portion 8a is pulled to start driving the motor 3, a speed of the rotation of the motor 3 is reduced by the planetary gear speed-reduction mechanism 21 and the hammer 41 is directly driven at a rotating speed in a predetermined ratio to the rotating speed of the motor 3. When the hammer 41 is rotated, its torque is transmitted to the anvil 46, so that the anvil 46 starts to rotate at the same speed as that of the hammer 41.

FIG. 2 is a perspective view showing an external appearance of the impact tool 1 shown in FIG. 1. The housing 6 is formed with three portions (6a, 6b and 6c). In the vicinity of the outer peripheral side in the radial direction of the cooling fan 18, the slits 26c are formed for exhausting cooling air. Further, in an upper surface of the battery holding portion 6c, a control panel 31 is provided. On the control panel 31, various kinds of operating buttons or display lamps are arranged. For instance, a switch for turning an LED light 12 on and off or a button for recognizing a residual amount of the battery pack 30 is arranged. Further, on a side surface of the battery holding portion 6c, a button switch 32 is provided for switching an operation mode (a drill mode, an impact mode) of the impact tool 1. When an operator presses the button switch 32 rightward, the drill mode and the impact mode are alternately switched.

In the battery pack 30, a release button 30a is provided. The battery pack 30 can be detached from the battery holding portion 6c by pressing release buttons 30a located at both right and left sides while moving the battery pack 30 forward. In right and left sides of the battery holding portion 6c, detachable belt hooks 33 made of metal are provided. In FIG. 2, the belt hook is attached to the left side of the impact tool 1. However, the belt hook 33 may be detached and attached to the right side of the impact tool 1. In the vicinity of a rear end part of the battery holding portion 6c, a strap 34 is attached.

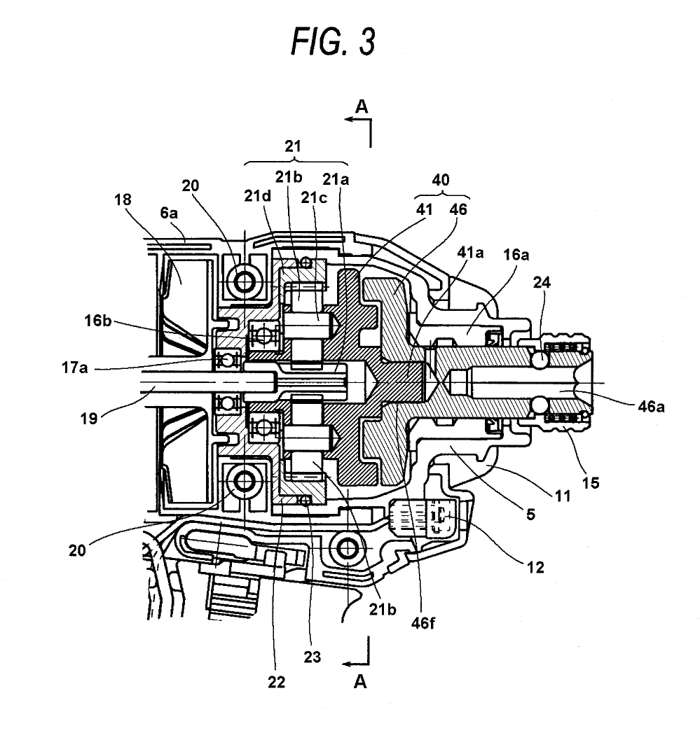

FIG. 3 is an enlarged sectional view of a part near the striking mechanism 40 shown in FIG. 1. The planetary gear speed-reduction mechanism 21 is a planetary type, and a sun gear 21a connected to an end of the rotary shaft 19 of the motor 3 serves as a driving shaft (an input shaft) and a plurality of planetary gears 21b rotate in an outer gear 21d fixed to the trunk portion 6a. A plurality of rotary shafts 21c of the planetary gears 21b is supported by the hammer 41 having a function of a planetary carrier. The hammer 41 rotates in the same direction as that of the motor 3 in a predetermined reduction gear ratio as a driven shaft (an output shaft) of the planetary gear speed-reduction mechanism 21. The reduction gear ratio may be suitably set based on factors such as a main object to be fastened (a screw or a bolt), an output of the motor 3 and a necessary fastening torque, etc. In the exemplary embodiment, the reduction gear ratio is set so that the rotating speed of the hammer 41 is about 1/8 to 1/15 times of the rotating speed of the motor 3.

In an inner peripheral side of the two screw bosses 20 in the trunk portion 6a, an inner cover 22 is provided. The inner cover 22 is manufactured by integral molding of synthetic resin such as plastic. In a rear part, a cylindrical portion is formed. The cylindrical portion holds the bearing 17a that fixes the rotary shaft 19 of the motor 3 so as to freely rotate. Further, in a front side of the inner cover 22, two cylindrical stepped portions which have different diameters are provided. In a small stepped portion, a ball type bearing 16b is provided. In a large cylindrical stepped portion, a portion of the outer gear 21d is inserted from a front side. Since the outer gear 21d is attached to the inner cover 22 so as not to freely rotate and the inner cover 22 is attached to the trunk portion 6a of the housing 6 so as not to freely rotate, the outer gear 21d is fixed to the housing 6 in a non-rotating state. Further, in an outer peripheral portion of the outer gear 21d, a flange portion is provided whose outside diameter is formed to be large. Between the flange portion and the inner cover 22, an O ring 23 is provided. To a rotating portion of the hammer 41 and the anvil 46, grease (not shown in the drawing) is provided. The O ring 23 performs sealing so that the grease does not leak to the inner cover 22 side.

In the exemplary embodiment, the hammer 41 functions as a planetary carrier that holds the plurality of rotary shafts 21c of the planetary gears 21b. Therefore, a rear end part of the hammer 41 is extended to an inner peripheral side of an inner ring of the bearing 16b. Further, an inner peripheral part of a rear side of the hammer 41 is arranged in an inner cylindrical space for accommodating the sun gear 21a attached to the rotary shaft 19 of the motor 3. In the vicinity of a central axis in the front side of the hammer 41, a fitting shaft 41a is formed as a shaft portion protruding forward in the axial direction. The fitting shaft 41a is fitted to a cylindrical fitting hole 46f formed in the vicinity of a central axis in a rear side of the anvil 46. The fitting shaft 41a and the fitting hole 46f are supported so as to be relatively rotated to each other.

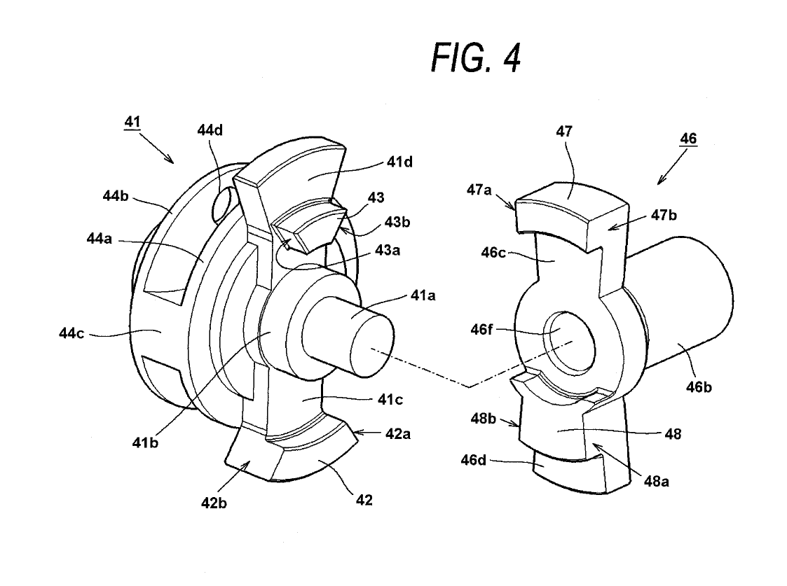

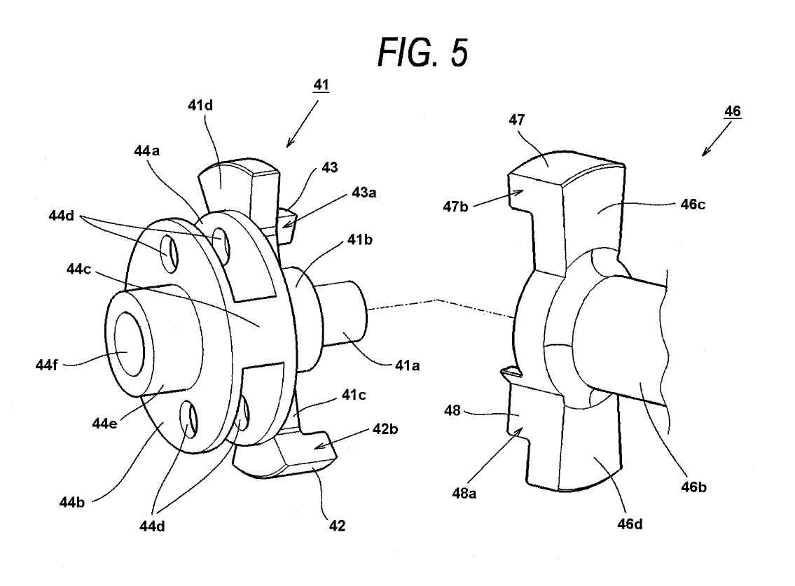

Hereinafter, referring to FIGS. 4 and 5, a detailed structure of the striking mechanism 40 shown in FIGS. 1 and 2 will be described. FIG. 4 is a perspective view showing the configuration of the hammer 41 and the anvil 46 according to the exemplary embodiment of the present invention. In FIG. 4, the hammer 41 is viewed from an obliquely front part and the anvil 46 is viewed from an obliquely rear part. FIG. 5 is a perspective view showing the configuration of the hammer 41 and the anvil 46 and shows a view in which the hammer 41 is viewed from an obliquely rear part and a partial view in which the anvil 46 is viewed from an obliquely front part. The hammer 41 includes two blade portions 41c and 41d diametrically protruding from a cylindrical main body portion 41b. The blade portions 41d and 41c respectively include protruding portions protruding in the axial direction. Further, the blade portions 41c and 41d respectively include one sets of striking portions and spindle portions.

An outer peripheral portion of the blade portion 41c is formed so as to expand in a sector shape. A protruding portion 42 which protrudes forward in the axial direction from is formed to the outer peripheral part of the blade portion 41c. The portion expanding in the sector shape and the protruding portion 42 function as the striking portion (striking pawl) and function as the spindle portion at the same time. In both sides in the circumferential direction of the protruding portion 42, striking-side surfaces 42a and 42b are formed. Both the striking-side surfaces 42a and 42b are formed in a plane and have suitable angles so as to effectively come into face contact with a struck- side surface of the anvil 46, which will be described later. On the other hand, in the blade portion 41d, an outer peripheral part is formed so as to expand in a sector shape. Therefore, the mass of the outer peripheral part of the blade portion 41d becomes large, so as to serve as the spindle portion. Further, a protruding portion 43 that protrudes forward in the axial direction from a part in the vicinity of a central portion in the diametrical direction of the blade portion 41d is formed. The protruding portion 43 serves as the striking portion (striking pawl). At both sides in the circumferential direction, striking-side surfaces 43a and 43b are formed. Both the striking-side surfaces 43a and 43b are formed in a plane and have suitable angles in the circumferential direction so as to effectively come into face contact with the struck-side surface of the anvil 46, which will be described later.

In the vicinity of the axis of the main body portion 41b and in the front side, the fitting shaft 41a that is fitted to the fitting hole 46f of the anvil 46 is formed. In a rear side of the main body portion 41b, two disk portions 44a and 44b and connecting portions 44c, which connect the disk portions together at two positions in the circumferential direction, are formed, so as to have the function of the planetary carrier. In the two positions respectively in the circumferential directions of the disk portions 44a and 44b, through holes 44d are formed. Between the disk portions 44a and 44b, the two planetary gears 21b (see FIG. 3) are arranged and the rotary shafts 21c (see FIG. 3) of the planetary gears 21b are attached to the through holes 44d. In a rear side of the disk portion 44b, a cylindrical portion 44e which extends in a cylindrical shape is formed. An outer peripheral side of the cylindrical portion 44e is supported by the inner ring of the bearing 16b. Further, in an inner space 44f of the cylindrical portion 44e, the sun gear 21a (see FIG. 3) is arranged. The hammer 41 and the anvil 46 shown in FIG. 4 and FIG. 5 are preferably formed by integral molding of metal in view of strength and weight.

The anvil 46 includes two blade portions 46c and 46d protruding in the diametrical direction from a cylindrical main body portion 46b. In the vicinity of an outer periphery of the blade portion 46c, a protruding portion 47 is formed which protrudes rearward in the axial direction. In both sides in the circumferential direction of the protruding portion 47, struck-side surfaces 47a and 47b are formed. On the other hand, in the vicinity of a central portion in the diametrical direction of the blade portion 46d, a protruding portion 48 which protrudes rearward in the axial direction is formed. In both sides in the circumferential direction of the protruding portion 48, struck-side surfaces 48a and 48b are formed. When the hammer 41 is normally rotated (rotated in a direction for fastening the screw), the striking-side surface 42a abuts on the struck-side surface 47a and the striking-side surface 43a abuts on the struck-side surface 48a at the same time. Further, when the hammer 41 is reversely rotated (rotated in a direction for unfastening the screw), the striking-side surface 42b abuts on the struck-side surface 47b and the striking-side surface 43b abuts on the struck-side surface 48b at the same time. The shapes of the protruding portions 42, 43, 47 and 48 are determined so that the abutment occurs at the same time.

As described above, according to the hammer 41 and the anvil 46, since striking is performed at two portions symmetrical with each other with respect to a rotating axis, a balance during the striking is good so that the impact tool 1 can hardly be swung during the striking. Further, since the striking-side surfaces are respectively provided in both the sides in the circumferential direction of the protruding portions, the striking can be performed not only during a normal rotation, but also during a reverse rotation. Thus, a convenient impact tool can be realized. Further, since a direction in which the anvil 46 is struck by the hammer 41 is only a circumferential direction, and the hammer 41 does not strike the anvil in the axial direction nor forward, the end tool is not pressed to a fastened member more than necessary during the impact mode. Thus, there is advantage when fastening a wood screw, and the like, to wood.

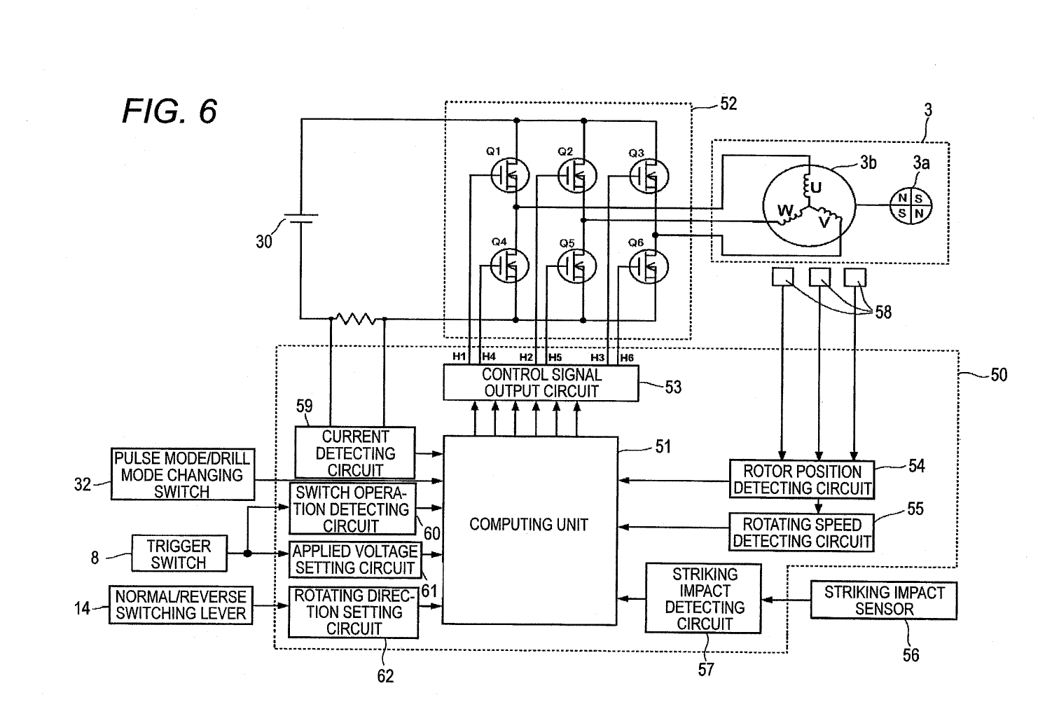

A structure and an operation of a driving control system of the motor 3 will be described hereinafter by referring to FIG. 6. FIG. 6 is a block diagram showing the structure of the driving control system of the motor 3. In the exemplary embodiment, the motor 3 is formed by the brushless DC motor of three phases. The brushless DC motor is a so-called inner rotor type and includes a rotor 3a including a permanent magnet having a plurality of sets (two sets in the exemplary embodiment) of N poles and S poles, a stator 3b including star-connected stator windings U, V and W of three phases and three rotating position detecting elements (hall elements) 58 arranged at predetermined intervals, for instance, at intervals of angles of 60° in the circumferential direction to detect the rotating position of the rotor 3a. In accordance with position detecting signals from the rotating position detecting elements 58, a current supply direction and time to the stator windings U, V and W are controlled and the motor 3 is rotated. The rotating position detecting elements 58 are provided at positions opposed to the permanent magnet 3c of the rotor 3a on the board 7.

An electronic element includes an inverter circuit 52 having six switching elements Q1 to Q6 such as FETs connected in a three-phase bridge form. Gates of the six bridge-connected switching elements Q1 to Q6 are respectively connected to a control signal output circuit 53 mounted on the control circuit board 9 and drains or sources of the six switching elements Q1 to Q6 are respectively connected to the star-connected stator windings U, V and W. Thus, the six switching elements Q1 to Q6 carry out switching operations in accordance with switching element driving signals (driving signals of H4, H5 and H6) inputted form the control signal output circuit 53 to supply an electric power to the stator windings U, V and W by considering DC voltage of the battery pack 30 applied to the inverter circuit 52 as three-phase (a U phase, a V phase and a W phase) voltages Vu, Vv, Vw.

Three negative power source side switching elements Q4, Q5 and Q6 of the switching element driving signals (three-phase signals) for driving the gates of the six switching elements Q1 to Q6 respectively are supplied as pulse width modulation signals (PWM signals) H4, H5 and H6, and pulse widths (duty ratio) of the PWM signals are changed by a computing unit 51 mounted on the control circuit board 9 in accordance with a detecting signal of an operation amount (a stroke) of the trigger operating portion 8a of the trigger switch 8 to adjust an amount of the supply of electric power to the motor 3 and control the start/stop and the rotating speed of the motor 3.

Here, the PWM signals are supplied either to positive power source side switching elements Q1 to Q3 or to the negative power source side switching elements Q4 to Q6 of the inverter circuit 52. The switching elements Q1 to Q3 or the switching elements Q4 to Q6 are switched at high speed to control the electric power supplied respectively to the stator windings U, V and W from the DC voltage of the battery pack 30. In the exemplary embodiment, since the PWM signals are supplied to the negative power source side switching elements Q4 to Q6, the pulse widths of the PWM signals are controlled so that the electric power supplied respectively to the stator windings U, V and W may be adjusted and the rotating speed of the motor 3 may be controlled.

In the impact tool 1, the normal/reverse switching lever 14 is provided for switching the rotating direction of the motor 3. Every time that a rotating direction setting circuit 62 detects a change of the normal/reverse switching lever 14, the rotating direction setting circuit 62 switches the rotating direction of the motor and transmits a control signal to the computing unit 51. The computing unit 51 includes a central processing unit (CPU) for outputting a driving signal in accordance with a processing program and data, a ROM for storing the processing program or control data, a RAM for temporarily storing the data, a timer and the like, which are not shown in the drawing.

The control signal output circuit 53 generates the driving signals for alternately switching predetermined switching elements Q1 to Q6 in accordance with output signals of the rotating direction setting circuit 62 and a rotor position detecting circuit 54 and outputs the driving signals to the control signal output circuit 53. Thus, a current is alternately supplied to a predetermined winding of the stator windings U, V and W to rotate the rotor 3a in a set rotating direction. In this case, the driving signals applied to the negative power source side switching elements Q4 to Q6 are outputted as the PWM modulation signals in accordance with an output control signal of an applied voltage setting circuit 61. A current magnitude supplied to the motor 3 is measured by a current detecting circuit 59 and the value is fed back to the computing unit 51 so that the current is adjusted so as to have a set driving electric power. The PWM signals may be supplied to the positive power source side switching elements Q1 to Q3.

A rotating speed detecting circuit 55 is a circuit that detects the rotating speed of the motor 3 and outputs the rotating speed to the computing unit 51, by using a plurality of signals of the rotor position detecting circuit 54 inputted thereto. A striking impact sensor 56 detects a level of the impact applied to the anvil 46 and an output thereof is inputted to the computing unit 51 through a striking impact detecting circuit 57. The striking impact sensor 56 can be realized by a strain gauge attached to the anvil 46. The motor 3 may be automatically stopped when a fastening operation is completed by a predetermined torque by using an output of the striking impact sensor 56.

In the impact tool 1 according to the exemplary embodiment, the motor can be rotated in the three driving modes (1) to (3) described below.
(1) Continuous driving mode A (having no electronic clutch function)
(2) Continuous driving mode B (having electronic clutch function)
(3) Intermittent driving mode

In the continuous driving mode A, the motor 3 is controlled simply, so that the hammer is continuously rotated to continuously rotate the anvil in one direction. In the continuous driving mode A, since a clutch mechanism is not used, to stop the rotation of the motor 3, an operator needs to turn off the trigger switch 8.

In the continuous driving mode B, the motor 3 is controlled simply, so that the hammer is continuously rotated to continuously rotate the anvil in one direction. The continuous driving mode B is basically same as the continuous driving mode A. However, since the clutch mechanism is electronically realized, the operator does not need to turn off the trigger switch 8. Even when the trigger switch 8 is continuously pulled, if a torque reaches a predetermined torque value, the rotation of the motor 3 is automatically stopped. A method for controlling an automatic stop of the motor 3 by the electronic clutch mechanism will be described later.

In the intermittent driving mode, the hammer is normally rotated and reversely rotated to strike the anvil, and the anvil is intermittently driven to rotate the end tool by a strong striking torque. Since the hammer 41 needs to be normally rotated and reversely rotated to strike the anvil 46, the motor 3 needs to be controlled uniquely. A unique control method is used in the intermittent driving mode, which can be realized by the hammer 41 and the anvil 46 according to the exemplary embodiment. In the intermittent driving mode, since the hammer 41 performs the striking, a fastening angle per time is smaller than that in the continuous driving mode. Thus, when fastening is performed by the impact operation, during an initial period of the fastening in which a necessary torque is low, the motor 3 is driven in the continuous driving mode A. When a reaction force of the object to be fastened is strong and the necessary fastening torque increases, the continuous driving mode is switched to the intermittent driving mode. Thus, a total time necessary for performing fastening in the impact mode can be shortened.

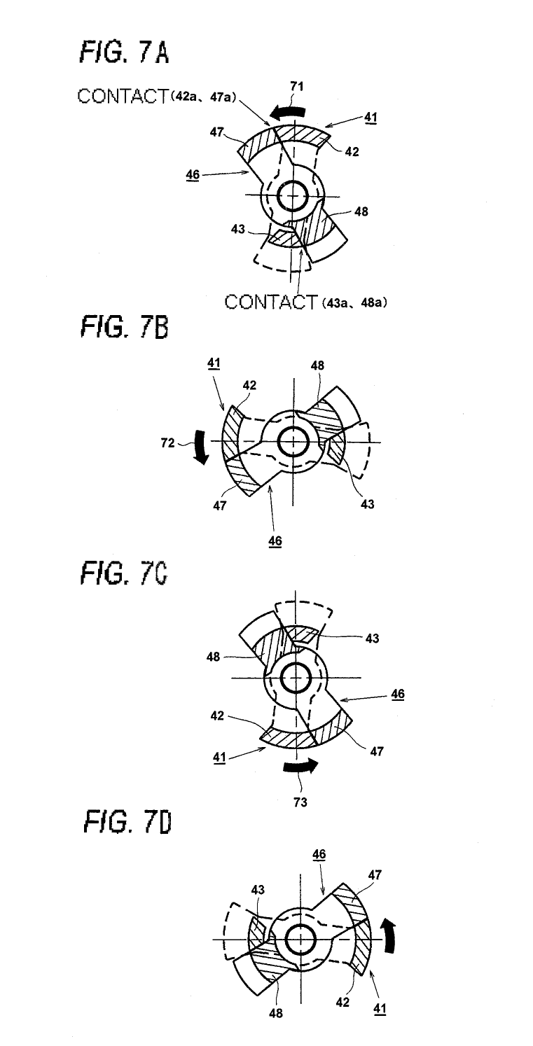

Hereinafter, the rotating operations of the hammer 41 and the anvil 46 will be described by referring to FIGS. 7 (7A, 7B, 7C, 7D) and 8 (8A, 8B, 8C, 8D, 8E, 8F). FIG. 7 is a sectional view taken along a line A-A in FIG. 3 and is a diagram for explaining a basic driving control of the hammer 41 in the above-described “continuous driving modes A and B”. From these sectional views, positional relations between the protruding portions 42 and 43 which protrude in the axial direction from the hammer 41 and the protruding portions 47 and 48 which protrude in the axial direction from the anvil 46 can be understood. A rotating direction of the anvil 46 during the fastening operation (during the normal rotation) is counterclockwise in FIG. 7. The hammer 41 is rotated in order of FIG. 7A, FIG. 7B, FIG. 7C and FIG. 7D by driving the motor 3. At this time, since the hammer 41 is continuously rotated in directions shown by arrow marks 71, 72, 73 and 74 by the the motor 3, the anvil 46 is pressed from a rear portion by the hammer 41. Under a state that the striking-side surfaces 42a and 43a of the hammer 41 come into contact with the struck-side surfaces 47a and 48a of the anvil 46, the anvil 46 is also synchronously rotated in the directions shown by the arrow marks.

As described above, in the impact tool 1 according to the exemplary embodiment, under a state that a load is small during the fastening operation, by only rotating the hammer 41 by the motor 3, the anvil 46 can be also synchronously rotated. Accordingly, the fastening operation or a drilling operation can be carried out by the end tool attached to the attaching hole 46a similarly to an ordinary driver drill.

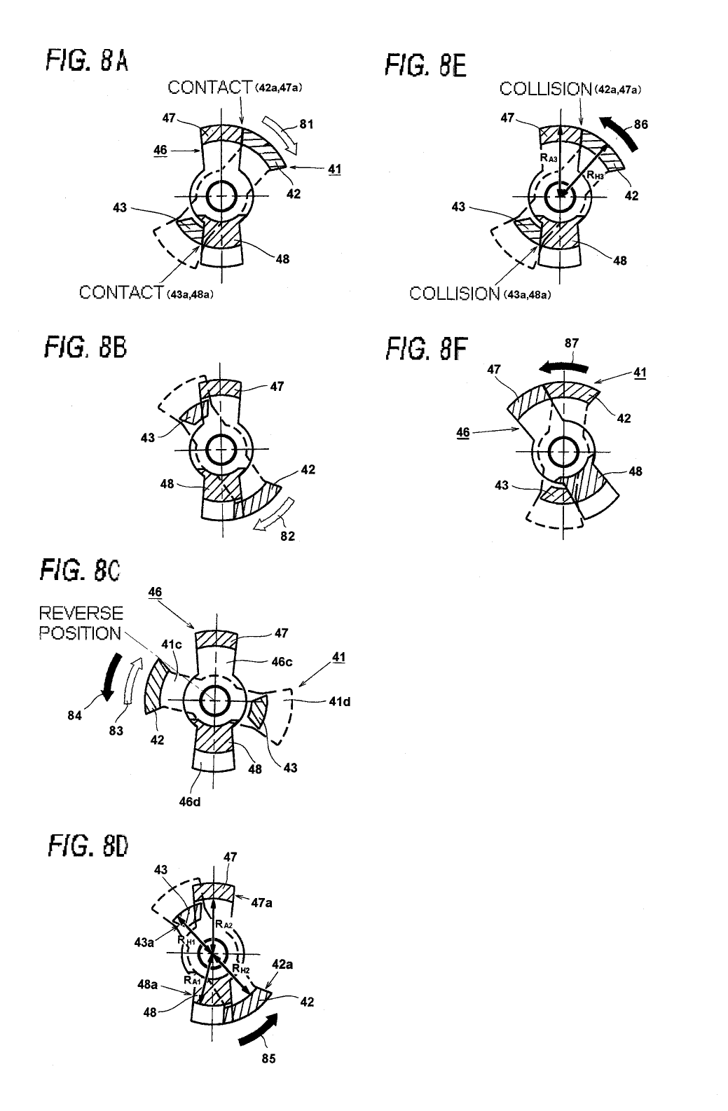

FIG. 8 is a sectional view taken along a line A-A in FIG. 3 and a diagram for explaining a basic driving control of the hammer 41 in the above-described “intermittent driving mode” of the impact tool 1. In the “intermittent driving mode”, not only the hammer 41 is rotated in one direction, but also the hammer 41 is moved forward and backward by driving the motor 3 in a unique method to strike the hammer 41 to the anvil 46. FIG. 8A is a diagram showing an initial state which is a state immediately after “the continuous driving mode” is switched to the “intermittent driving mode”. The hammer 41 is rotated in a direction shown by an arrow mark 81 (an opposite direction to the rotating direction of the anvil 46) by starting the reverse rotation of the motor 3 from this state.

Since the hammer 41 can be swung at a rotation angle smaller than 360 degrees relative to the anvil 46, when the motor 3 is reversely rotated, it is possible to reversely rotate only the hammer 41 from the state shown in FIG. 8A. At this time, the rotation of the anvil 46 remains stopped. When the motor 3 is reversely rotated to a state near a state shown in FIG. 8B, a reversely rotating drive of the motor 3 is stopped. However, the hammer 41 is continuously rotated in a direction shown by an arrow mark 82 due to inertia and reversely rotated to a position shown in FIG. 8C. When a driving current in a normally rotating direction is supplied to the motor 3 to normally rotate the motor, just before the position shown in FIG. 8C, the rotation of the hammer 41 in a direction shown by an arrow mark 83 is stopped to start a rotation in a direction shown by an arrow mark 84 (a rotation in a normal direction). Here, a position where a rotating direction of the hammer 41 is reversed is referred to as a “reverse position”. In the exemplary embodiment, a rotation angle from a start of a rotation to the reverse position of the hammer 41 is about 240°. This reverse angle may be arbitrarily set within a maximum reversible angle and is preferably set in accordance with a required value of the fastening torque by the striking.

When the rotating direction of the hammer 41 is reversed, the hammer 41 is normally rotated again. As shown in FIG. 8D, the protruding portion 42 again passes an outer peripheral side of the protruding portion 48 and the protruding portion 43 passes an inner peripheral side of the protruding portion 47 at the same time, and the hammer is accelerated and continuously rotated in a direction shown by an arrow mark 85. In such a way, to allow both the protruding portions 42 and 43 to pass, an inside diameter R_{H2} of the protruding portion 42 is formed to be larger than an outside diameter R_{A1} of the protruding portion 48, so that both the protruding portions 42 and 48 do not collide with each other. Similarly, an outside diameter R_{H1} of the protruding portion 43 is formed to be smaller than an inside diameter R_{A2} of the protruding portion 47, so that both the protruding portions 43 and 47 do not collide with each other. According to such a positional relationship, the relative rotation angle of the hammer 41 and the anvil 46 can be formed to be larger than 180° and a sufficient amount of the reverse angle of the hammer 41 relative to the anvil 46 can be ensured. The reverse angle represents an accelerating zone before the hammer 41 strikes the anvil 46.

Then, when the hammer 41 is accelerated in a direction shown by an arrow mark 86 and rotated to a state shown in FIG. 8E, the striking-side surface 42a of the protruding portion 42 collides with the struck-side surface 47a of the protruding portion 47. At the same time, the striking-side surface 43a of the protruding portion 43 collides with the struck-side surface 48a of the protruding portion 48. In such a way, since the hammer collides with the anvil at two positions opposite to each other with respect to the rotating axis, the hammer 41 strike the anvil 46 in a good balance.

As a result of the striking, as shown in FIG. 8F, the anvil 46 is struck from a rear portion by the hammer 41 to be rotated in a direction shown by an arrow mark 87. Thus, the fastened member is fastened by the rotation caused by the striking. The hammer 41 includes the protruding portion 42 as the only protrusion at a concentric position in the diametrical direction (a position equal to R_{H2} or larger, and equal to R_{H3} or smaller) and the protruding portion 43 as the only protrusion at a concentric position (a position equal to R_{H1} or smaller). Further, the anvil 46 has the protruding portion 47 as the only protrusion at a concentric position in the diametrical direction (a position equal to R_{A2} or larger and equal to R_{A3} or smaller) and the protruding portion 48 as the only protrusion at a concentric position (a position equal to R_{A1} or smaller). As described above, in the “intermittent driving mode”, the motor 3 is alternately rotated in a normal direction and a reverse direction to alternately rotate the hammer 41 in the normal direction and the reverse direction, thereby striking the anvil 46.

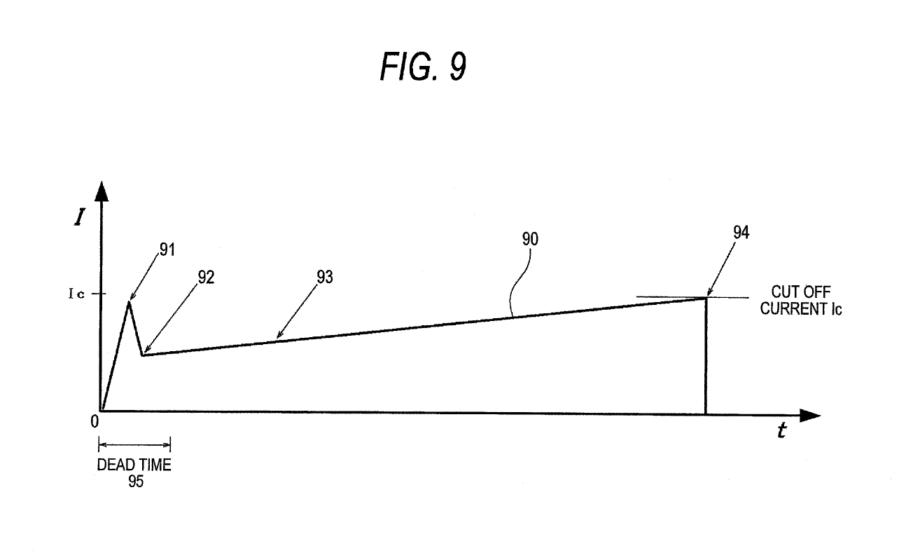

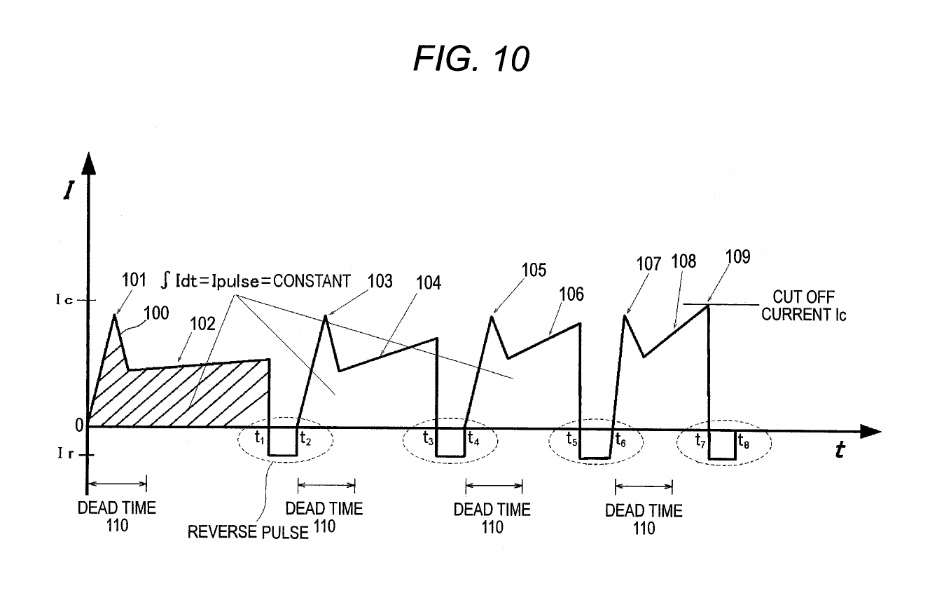

Hereinafter, a driving method of the motor 3 in the “continuous driving mode” of the impact tool 1 according to the exemplary embodiment will be described below by referring to FIG. 9 and FIG. 10. FIG. 9 is a current wave form diagram showing a basic control method of the motor 3 in the “continuous driving mode” described in FIG. 7. In FIG. 9, a horizontal axis shows an elapse time t (milli-seconds) and a vertical axis shows a driving current I(A) supplied to the motor 3. When the operator pulls the trigger operating portion 8a at a time t, the motor 3 is started. At this time, in a current magnitude 90 detected by the current detecting circuit 59, immediately after the start of the rotation, a so-called starting current, which is a large current as shown by an arrow mark 91, is supplied. Then, when the rotor 3a is started to rotate and accelerated, the current magnitude 90 decreases. Eventually, the current magnitude is settled to a value shown by an arrow mark 92, at the vicinity of a target rotating speed of the motor 3. However, when a fastening reaction force from the end tool attached to the anvil 46 increases, a reaction force transmitted to the hammer 41 from the anvil 46 increases. Accordingly, to maintain the rotation of the motor 3 at the target rotating seed, the computing unit 51 controls the current supplied to the motor 3 to be increased. As a result, the current magnitude 90 is gradually increased as shown by an arrow mark 93.

Then, at a spot shown by an arrow mark 94, since the current reaches a cut off current Ic, the computing unit 51 considers that the fastening operation by a necessary fastening torque is completed. Then, in the drill mode, the computing unit 51 stops the supply of the PWM signal to the inverter circuit 52 to stop the rotation of the motor 3. On the other hand, in the impact mode, the computing unit 51 considers that a fastening torque reaches a maximum fastening torque in the “continuous driving mode”, and switches the “continuous driving mode” to the “intermittent driving mode” described in FIG. 8 to rotate the anvil 46 by the striking of the hammer 41.

In FIG. 9, a magnitude of the cut off current Ic is set arbitrary. For instance, the magnitude of the cut off current may be set to correspond to values set in a plurality of levels by a user. Further, the computing unit 51 monitors whether or not the current magnitude 90 exceeds the cut off current Ic. However, since the starting current flows immediately after the start of the motor 3, the current magnitude 90 may exceed the cut off current Ic. Therefore, during a predetermined period immediately after the start, it is preferred to provide a dead time 95 in which the magnitude of the current magnitude 90 is not compared with the cut off current Ic. It is controlled that the current magnitude 90 begins to be compared with the cut off current Ic after the dead time 95 has elapsed.

FIG. 10 is a current wave form diagram showing a control method of the motor 3 in an improved “continuous driving mode”, namely, a “coming-out preventing mode”, which is the most characteristic control method of the present invention. As can be understood from FIG. 10, a current magnitude 100 supplied to the motor 3 is controlled so as not to be continuously supplied, but to be intermittently supplied. Further, after a predetermined amount of normal current for rotating the rotor in the normal rotating direction is supplied to the motor, (for instance, at t₁), a predetermined reverse current Ir for rotating the motor in a reversed direction is supplied for a short time (t₁ to t₂), and then, a normal current is supplied again. At the time t₁, since the motor 3 is rotated at a certain rotating speed, even when the reverse current is supplied for a short time at that time, the motor 3 itself is not reversely rotated and the hammer 41 is continuously rotated. There is merely a slight decrease in the torque. Further, since the rotation of the hammer 41 is transmitted in the reduction gear ratio of about 1/15, and due to the planetary gear speed-reduction mechanism 21 or the allowance of the hammer 41 and the anvil 46, there is hardly any decrease in the rotation of the hammer 41. The rotating torque of the hammer 41 merely seems to momentarily slip out during the time t₁ to t₂. During that time, since a fastening member such as a wood screw is continuously rotated due to inertia, the rotating torque of the anvil 46 may be lowered as if the rotating torque momentarily slipped out, and the striking-side surface 42a and 43a of the hammer 41 may be separated from the struck-side surfaces 47a and 48a of the anvil 46. A distance of the separation is different depending on the magnitude of the reaction force from the fastening member. In some cases, only the anvil 46 moves forward, thereby separating the hammer 41 from the anvil 46 by a rotation angle of about several degrees. However, the rotation direction of the hammer 41 is unchanged. That is, the hammer 41 is merely continuously rotated in the same direction.

At the time t₂, when a normal current is supplied again to the motor 3, the current magnitude 100 suddenly rises as shown by an arrow mark 103, falls again and is gradually increased in accordance with the rise of a load as shown by an arrow mark 104. Then, at time t₃, the supply of the rotating current in the normal direction to the motor 3 is changed to the supply of the predetermined reverse current Ir to the motor 3. Times t₁, t₃ and t₅ as timings for supplying the reverse current Ir are set so that an area of a closed region formed by the horizontal axis and the current magnitude 100 in the normal direction is constant, namely, a below-described mathematical expression 1 is established.

∫Idt=Iₚᵤₗₛₑ=constant [Mathematical Formula 1]

I represents a current (A) supplied to the motor 3 and Iₚᵤₗₛₑ represents a previously set predetermined value (a threshold value). The computing unit 51 starts a calculation of integration in accordance with the mathematical expression 1 from, for instance, a voltage value for each milli second on the basis of an output of the current detecting circuit 59. Starting timings are times 0, t₁, t₂, t₄ and t₆. When a calculated value reaches an integrated value Iₚᵤₗₛₑ, the computing unit 51 controls the reverse current Ir to be supplied to the motor 3. Ordinarily, in fastening the wood screw, as the fastening operation is advanced more, the reaction force received from the fastening material increases. That is, the current magnitude 100 gradually increases. Meanwhile, since Iₚᵤₗₛₑ is constant, times period between t₂ and t₃, t₄ and t₅, and t₆ and t₇ gradually becomes short. However, the magnitude of the reverse current Ir as a reverse pulse to the motor 3 and a time period of supplying the reverse current to the motor are constant. The magnitude of Ir or a supply time period may be previously set and stored in a microcomputer included in the computing unit 51.

As described above, according to the impact tool 1 of the exemplary embodiment of the present invention, since the current magnitude 100 supplied to the motor 3 is monitored, and a small amount of reverse pulse is supplied every time a predetermined amount of driving is performed, the rotating torque is lowered et the every time, as if the rotating torque momentarily slipped out during the rotation of the anvil 46, thereby effectively recovering an engagement of the anvil 46 with a screw head. Accordingly, the engaged state of the end tool with the screw head, where the coming-out may occur, can be effectively recovered. Thus, the occurrence of the coming-out can be effectively prevented while continuously performing the fastening operation.

In the exemplary embodiment, whether or not the fastening operation is completed can be recognized by monitoring the cut off current Ic in the same manner as described in FIG. 9. Namely, the computing unit 51 continuously monitors the current magnitude 100 supplied to the motor 3 to decide whether or not the current magnitude 100 exceeds the cut off current Ic. When the current magnitude 100 exceeds the cut off current Ic, the computing units 51 considers that the fastening operation is completed at the predetermined fastening torque and stops the rotation of the motor 3. When the fastening operation is performed together with the striking operation, the “coming-out preventing mode” shown in FIG. 10 may be switched to the “intermittent driving mode” as shown in FIG. 8. Here, immediately after the start of the motor 3 or immediately after the normal current is supplied (time t₂, t₄, t₆), a dead time 110 is provided similarly to FIG. 9. It is preferred that the current magnitude 100 is begun to be compared with the cut off current Ic after the dead time 10 elapses.

In the exemplary embodiment, as another evaluation method for completing the fastening operation by the “coming-out preventing mode”, it is determined whether a unit time during which the normal current is supplied, namely, time between 0 and t₁, t₂ and t₃, t₄ and t₅, or t₆ and t₇, is shorter than the predetermined threshold value. When the time is shorter than the threshold value, the motor 3 may be controlled to stop or the “coming-out preventing mode” may be controlled to be switched to the “intermittent driving mode”.

As described above, according to the exemplary embodiment, in the electric tool in which the hammer and the anvil having a relative rotation angle smaller than one turn are used to rotate the anvil in a constant direction (one direction), not only the impact mode, but also the drill mode can be easily realized. Further, since the intermittent control as shown in FIG. 10 is performed in the fastening in the drill mode, the occurrence of a so-called a coming-out, in which the bit of the end tool surmounts the screw head of the screw, can be greatly reduced.

The present invention has been described in accordance with the exemplary embodiment. However, the present invention is not limited thereto and various changes in form and details may be made therein without departing from the spirit and scope of the invention. For instance, in FIG. 10 of the above-described exemplary embodiment, the reverse current Ir is controlled to be supplied to the motor 3 at t₁ to t₂, t₃ to t₄, t₅ to t₆ and t₇ to t₈. However, the supply of the current may be stopped (I=0) or a normal current extremely near to 0 may be supplied in place of the supply of the reverse current Ir. Further, although an impact tool is described in the specification, the present invention is not limited to this, and may also be applied to an electric tool having a connecting mechanism that can rotate relatively by about several degrees to several tens of degrees or has a predetermined allowance in a rotating direction.

### INDUSTRIAL APPLICABILITY

According to an aspect the present invention, there is provided an impact tool that can realize an impact mechanism by a hammer and an anvil having a simple mechanism and can also be used in a so-called drill mode without operating the impact mechanism.

According to another aspect of the present invention, there is provided an impact tool that realizes a drill mode which can greatly restrain a screw and the like from coming-out by designing a driving method of a motor so as to drive a hammer and an anvil in a relative rotation angle smaller than 360 degrees.

According to another aspect of the present invention, there is provided an impact tool that controls a rotation of a motor so as to be capable of accurately responding to increase of a fastening load from a fastening object.

1. An impact tool comprising:
a motor;
a speed-reduction mechanism that reduces a torque of the motor;
a hammer connected to an output portion of the speed-reduction mechanism; and
an anvil that can be swung relatively to the hammer,
wherein the hammer is directly driven by the motor, and
wherein the impact tool can operate in:
a drill mode in which an end tool attached to the anvil is rotated by rotating the hammer in one direction so as to rotate the anvil; and
an impact mode in which the end tool attached to the anvil is rotated while the hammer intermittently strikes the anvil.

2. The impact tool according to claim 1,
wherein the hammer can be swung at a rotation angle smaller than 360 degrees relative to the anvil.

3. The impact tool according to claim 2,
wherein the motor is intermittently driven in the drill mode.

4. The impact tool according to claim 3,
wherein the motor is intermittently driven by alternately supplying to the motor, a first current for rotating the motor in a normal direction, and a second current for rotating the motor in a reverse direction for a short period of time.

5. The impact tool according to claim 3,
wherein the motor is intermittently driven by alternately repeating, supplying the first current to the motor, and stopping the supply of the current to the motor for a short period of time.

6. The impact tool according to claim 5,
wherein an integrated value of the first current is calculated, and
wherein it is switched from supplying the first current to supplying the second current or stopping the supply of the current when the integrated value reaches a predetermined value.

7. The impact tool according to claim 6,
wherein the short period of time, during which the second current is supplied or the supply of the current is stopped, is a predetermined time which is previously set.

8. The impact tool according to claims 1,
wherein a magnitude of the first current is monitored, and
wherein the rotation of the motor is stopped when the magnitude of the first current reaches a predetermined value.

9. The impact tool according to claim 5,
wherein a time required until the integrated value of the first current reaches a predetermined value is monitored, and
wherein when the time is equal to a predetermined value or smaller, the rotation of the motor is stopped or the mode is shifted to the impact mode.
